(19) United States
(12) Patent Application Publication
(10) Pub. No.: US 2026/0047532 A1
(43) Pub. Date: Feb. 19, 2026

(54) Machine, Means For Controlling The Compaction Of A Substrate And Product Obtained

(71) Applicant: INVESTWEILER PARTICIPACOES LTDA, Sao Paulo (BR)

(72) Inventors: Ricardo BRAGOTTO, Sao Paulo (BR); Ricardo FORNERIS, Sao Paulo (BR)

(73) Assignee: INVESTWEILER PARTICIPACOES LTDA, Sao Paulo (BR)

(21) Appl. No.: 19/104,092

(22) PCT Filed: Jul. 4, 2023
(86) PCT No.: PCT/BR2023/050231

§ 371 Date: Feb. 14, 2025

(30) Foreign Application Priority Data
Aug. 12, 2022 (BR) 1020220160589

(51) Int. Cl. A01G 9/08; B65B 25/02; B65B 57/10; B65B 61/06; B65B 63/02

(52) U.S. Cl. CPC A01G 9/081; B65B 25/02; B65B 57/10; B65B 61/06; B65B 63/02

(57) ABSTRACT

The machine, means for controlling the compaction of a substrate and product obtained relates to a machine that controls the compaction of a substrate, with improvements in the production process that are automated and without losses in the production of small paper tubes or any type of non-woven tissue for use in propagating seedlings and plants.

The present patent application refers to the control and improvement of the compaction of a substrate. More precisely, an improvement in the production process of the container for the cultivation of seedlings and plants through the machine that conducts the said process and the improvement in the product obtained.

BACKGROUND—We found in the INPI's patent database and in international databases, such as Espacenet, PatentScope, Google Patents, some patent applications and patent registrations that are relevant for obtaining knowledge of the State of the Art, the problems faced and the improvements brought about by the present patent application that were motivated by these problems. Below, we will highlight some of them.

BR1120140290440—METHOD OF MANUFACTURING A PLANT RECEPTACLE; AND MANUFACTURED PLANT RECEPTACLE, refers to a method of manufacturing a plant receptacle wherein the following steps are carried out: a) a PLA yarn is co-extruded with a flexible aliphatic polyester, said flexible aliphatic polyester comprising 10% by weight to 30% by weight of bamboo material, so that the aliphatic polyester cover the PLA thread, thereby creating a biodegradable weldable thread; b) use of said biodegradable weldable thread in a woven or non-woven fabric (TNT) process, resulting in a permeable sheet material; c) continuous formation of said sheet material in a continuous receptacle, placing the lateral edges of the said sheet material in contact and welding said lateral edges; d) cutting said continuous receptacle in predetermined lengths, thus creating separate plant receptacles.

BR1120160100905—METHOD OF MANUFACTURING PLANT RECEPTACLE, AND PLANT RECEPTACLE, refers to a method of manufacturing a plant receptacle wherein the following steps are carried out: a) providing a fiber mixture, said mixture comprising at least PLA fibers and a biodegradable fiber; b) using said fiber mixture in an interlaced or non-interlaced process, making a permeable sheet material; c) continuously forming said sheet material in a continuous receptacle placing the lateral margins of said sheet material in contact and welding said lateral margins together; d) cutting said continuous receptacle into predetermined lengths, thereby creating separate plant receptacles or wherein said continuous receptacle is pierced substantially perpendicular to the longitudinal direction of the continuous receptacle at predetermined intervals, thus allowing to separate the plant receptacles to be detached from the continuous receptacle.

US6195938—Seedling container and method of making the same, which refers to a seedling container and a method of making the same, which includes a sleeve filled with a compressed plant growth medium and having a first end, a second end and a defining sidewall. The side wall has at least one integrally formed tear strip extending between the first end and the second end. The detachable strip allows the sleeve to be removed easily to allow a seedling to be planted which is wrapped in plant growth medium.

KR101286229—Biodegradable cellulose fiber seeding pot and the preparation process thereof, which refers to a biodegradable seedling pot using a cellulose fiber and a method for the production thereof. The biodegradable seedling pot according to present invention includes a moisture resistance agent (WSA), a water-soluble wax and an alkyl ketene dimer (AKD) as an internal additive, and the PLA is coated with a biodegradable water repellent agent on the surface of the vessel. Seedling pot. Water repellency, moisture resistance, drought resistance, breathability and biodegradable properties are excellent, when the crop is grown in the harbor of biodegradable seedlings, the culture growth is excellent, the root of the crop is high. In addition, the biodegradable seedling vessel according to present invention is of low cost and environmentally friendly by recycling the paper used and can be formulated as a seedling pot during formal work, the formal work is simple compared to the conventional plastic seedling pot.

STATE OF THE ART—In the current state of the art, as shown by the processes and/or records researched above, there is no application, recorded or abandoned or expired that involves a machine with automated process to perform compaction with the controls necessary for a better result and with less losses. This being said, the problem presented made the inventor create an automated machine and process thereof that could operate producing receptacles through a reducing and controlling system of losses, thus generating higher quality products at a lower cost and at a higher speed, that is, increasing the efficiency of production, resulting from the reduction of losses, meaning losses of the products themselves, of their materials and of the energy employed in the machines. The better the quality, the lower the losses, the lower the costs and the energy consumption in manufacturing. One way of measuring quality is to check the final product for the compaction of the substrates, such as the earth, and the quality of the biodegradable tubes that receive the seedlings. In the latter case, the tubes cannot be degraded ahead of time, they must receive the best possible quantity of substrate and necessary for each type of plant, and, when planted, they must degrade in the correct time, without causing damage to the environment and allowing the plant to grow.

The existing systems for the production of seedlings in receptacles are controlled by the travel time of the electro-pneumatics without taking into consideration the degree of compaction of the substrate and the quality of the biodegradable tubes, that is, they measure only the working time of the machine and calculate, in an non-precise estimate using empirical information from previous production counts, to estimate the quantity of seedlings produced, which generates a large margin of error in counting and quality, considering, for example, that each substrate and each type of seedling, for various reasons, such as size and type of root, demand a certain degree of compaction, forcing the machine to fill the seedlings at different times and powers. The same applies to the type of receptacle, some more sensitive than others, requiring different treatment. If the machine produces tubes with different degrees of compaction, the uniformity of root development will not be guaranteed in the production of seedlings and plants, and in this way will jeopardize the development and quality of seedlings and their production. Another point to be considered is that the production of deformed tubes will cause the loss of the biodegradable tube, which has a considerable cost, generating losses both in terms of material (biodegradable paper) and productivity (production of seedlings per hour) to the producer/nursery worker, with the repercussions on costs and the environment by the greater production of unused material and energy wasted both in the production of material and in the use of energy in the machines themselves.

Another point that should be taken into consideration is that for the correct traction of the biodegradable tube cylinder, formed by the biodegradable paper already filled by the substrate, and the cutting thereof, between the filler chamber and the cutting system, a minimum degree of compaction is required, which, if not achieved, will generate the breakdown of the biodegradable paper and/or irregular and unwanted sizes in the length of the tube, in addition as a consequence the interruption of the production of the tubes and a substrate spill, thus greatly increasing the inefficiency of the process and the substrate losses, as shown in the current state of the art.

Another important drawback of current systems, including machines and processes, is that there is no way to automate in an integrated manner the processes of producing tubes, since there is no means of checking to supervise whether the main cylinder remains intact to be transported and cut into tubes, and human visual supervision is always necessary. Therefore, the control of the substrate level in the storage funnel currently requires several controls and consequently has an excessive cost due to people's working hours and the large margin of error. Even at the end of the productive shifts, specialized labor is required so that it is possible to synchronize visually and manually the level of the substrate in the funnel and the time to interrupt the operation of cutting the tubes so that no undue filling and compaction occurs, nor the rupture of the biodegradable paper, that is, the current models do not allow an output that is homogeneous and cheap, given the need for human supervision, highly variable. Current systems are based on machine running time and cutting of biodegradable paper tubes or a biodegradable paper tubes production process that evaluates the compaction and aeration state of the substrate in the equipment vacuum filler chamber manually. Thus, there is a need for a machine and process that makes it possible to automatically check the parameters of controls, such as compaction, with a measurement of the aeration of the substrate, and sending a signal in an automated manner to the traction system, making the travel of the biodegradable cylinder/tube and the cutting thereof capable of being controlled and moved in accordance with previously informed parameters.

The current systems are based on the time travel of the travelling and cutting sets of the biodegradable paper tubes.

OBJECTIVES—Aiming at improving the production process of a container for growing seedlings and plants in a cylindrical form with the open top, an open bottom ready to receive a seed, a stake or a plant in a growth medium, known as a substrate, that provides a suitable root development for the propagation of seedlings and plants, with quality control and compaction, the applicant created a control device for the machine that through its automated operation conceives such a container with side wall that can be composed of a flexible biodegradable material, but sufficiently rigid to be self-supporting of the substrate, ensuring its degree of compaction and thus maintaining its tubing structure during the root development of seedlings and plants.

The side wall of the tube can also be prepared to receive sensors that make possible its tracking. In certain configuration options, the sidewall can contain openings or have handles placed on them for ease of transport. The container is used by placing a seed or plant and a growth medium, then packing this container in appropriate trays or structures, enabling ideal conditions of temperature, humidity, pruning above and proper spacing. The seedling or plant can be placed in the soil or in a larger biodegradable container without the need to remove it from the previous container, causing no stress to the plant during transplantation.

In the present invention, tubes are produced by filling a tube with porous material that allows control of the degree of compaction and aeration of the filler material, forming biodegradable paper products in which a reliable control of compaction of the substrate is still allowed for application in the propagation of seedlings and agricultural plants.

To do so, in this application there is the general control of the biodegradable tube forming process through the monitoring of the internal absolute pressure of the filling chamber, in this way the control system is no longer temporal, and, on the other hand, controlled by the density and quality of the substrate filling in the biodegradable tube.

FIGURES—For a better and adequate understanding of the invention, the same is described below with the aid of the attached figures.

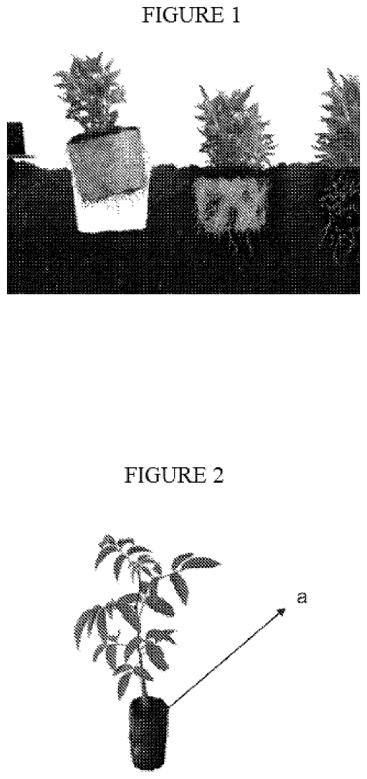

FIGS. 1 and 2 illustrate examples of biodegradable tubes, paperpot, paper pot.

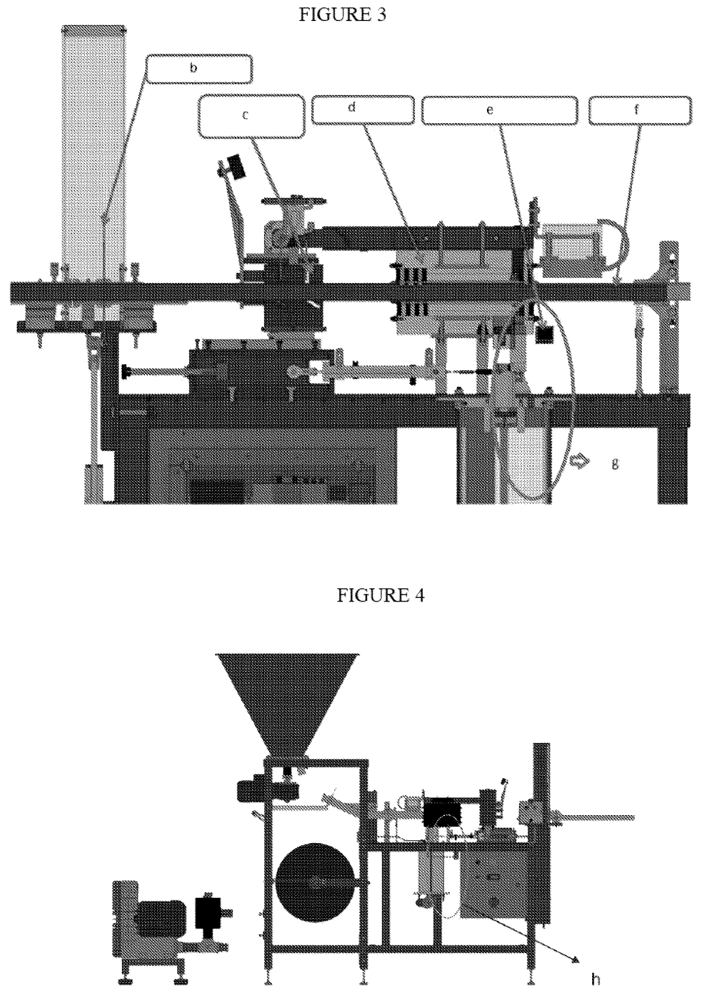

FIG. 3 shows a partial schematic drawing of the paperpot production machine including technological innovation.

FIG. 4 reveals a full side view of the technological innovation prototype.

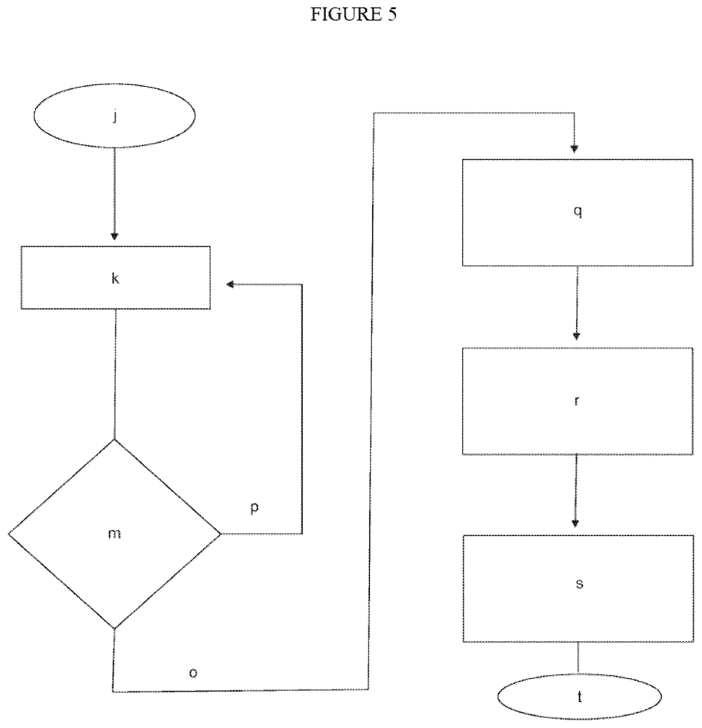

FIG. 5 identifies the flow chart of the control of compression degree.

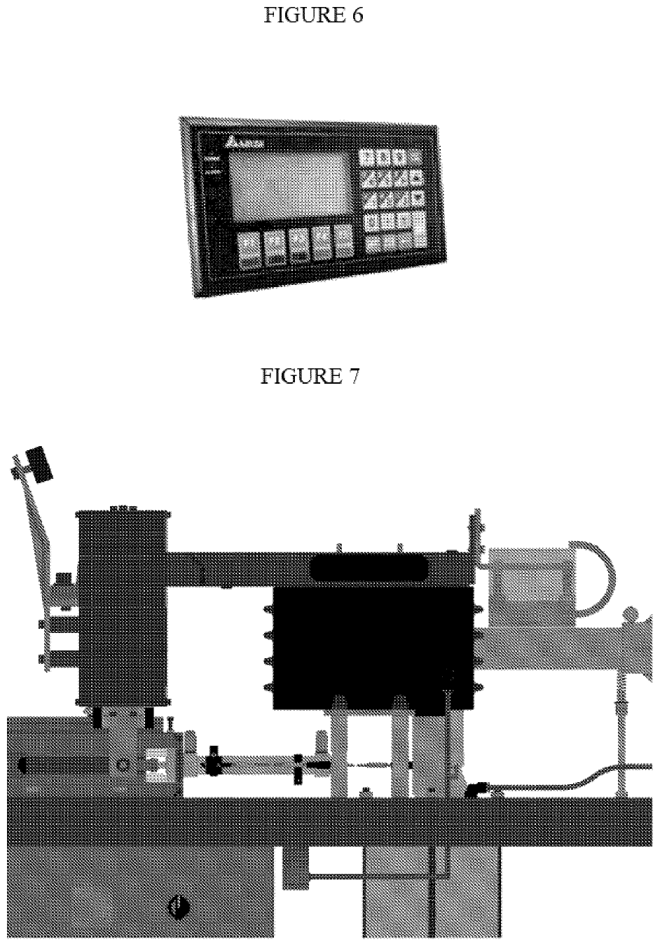

FIG. 6 refers to an example of UHM—Human Machine Interface to be introduced in technological innovation.

FIG. 7 refers to the part of the machine that has been improved, more precisely the filler box, where a pipe is placed to measure the variation of atmospheric pressure inside it, to measure the degree of compaction, as shown in FIG. 9.

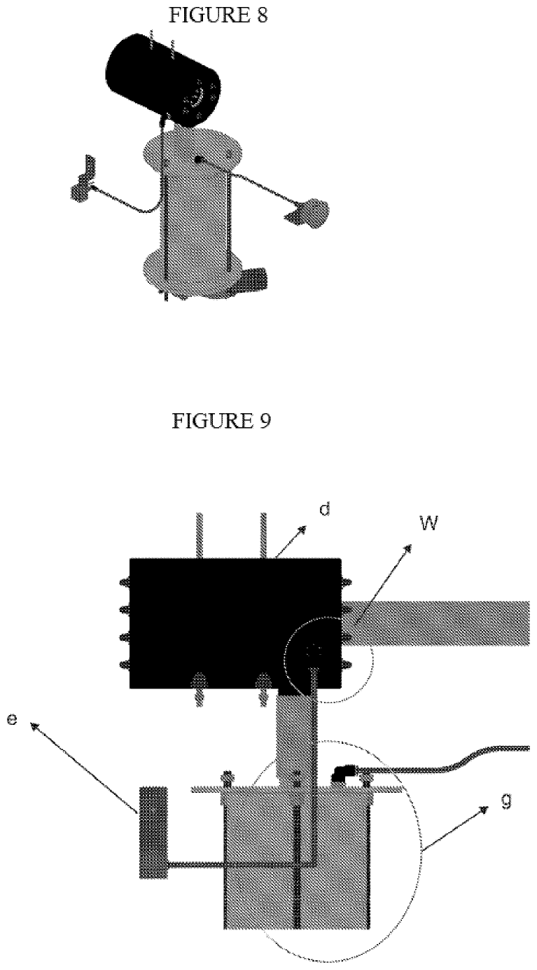

FIG. 8 shows the parts that have been changed in detail from FIG. 7/9 to the original design.

FIG. 9 shows the detail of the design that identifies the innovation in which the pressure variation is allowed to be read.

DETAILED DESCRIPTION—According to the described previously, the technological innovation deals with a machine (3,4) with a device (FIG. 9, w, e) that monitors when the compaction process is in place and a sensor to measure the pressure in the vacuum (FIG. 9 e) that measures the degree of compaction of the final product to verify that the tube has been filled correctly. Said machine (3,4), has a tube cutting system (b), paper traction unit+substrate (c), filling chamber (d), compaction degree control system (e, h), biodegradable paper tube (f) and vacuum chamber (g).

The flowchart (e, h) of the machine (5) reveals the following automation system: the process is started (j) opens up (k) the vacuum chamber valve (g) connected to the filling box, the monitoring/sensor system identifies if there is pressure difference (m) inside the filling chamber (d)—if there is no difference, thus pointing that the degree of compression of the substrate is adequate, the vacuum chamber valve remains open (k). Once the pressure level indicates the correct degree of compaction, the process is terminated and closes (k) the vacuum valve of the filler box (d), (q) and advances the traction unit of the tube+substrate to form one more piece of the biodegradable paper tube (c), and finally it follows(s) to the tube cutting system (b), terminating the process (t).

The mechanical innovations conducted in the vacuum chamber where the compaction is done (d) include the inclusion of a hole to fit the system for measuring the variation of atmospheric pressure (W) inside the vacuum chamber. The existing machines do not have this vacuum measurement control for measuring the compaction of the substrate in the paperpot production.

The electronic signals coming from the sensor (e) are processed by a computational system, CLP or man-machine interface IHM, and the system's travelling routine controls the travelling signals of the whole assembly, based on the level of compression and no longer on the timing.

In the production cycle, only when the compaction reaches the correct level by the system compaction, sensor, vacuum pump measurement (d and g), the traction system (c) is actuated and after the substrate tube is pulled into the correct length it is cut (b).

The new technology allows the control of the production process, avoiding the waste of raw material, since it guarantees the proper compaction, as well as guaranteeing a uniformity of the production of the seedlings. This new solution significantly reduces process losses and guarantees better final quality of the seedlings produced.

With the guarantee of the substrate compaction throughout the production of tubes, we have the following advantages: a) no breakage of the biodegradable paper because if the compaction is not adequate there is no movement of the filled tube from the filler box to the cutting unit; b) as the biodegradable paper does not break no more substrate spill occurs; c) as the production of tube only occurs when the degree of compaction is adequate it is possible to automate the production not depending on human supervision; d) when the substrate is at the end in the storage funnel, it forces the no filling of the biodegradable paper tube inside the filling chamber, consequently it does not reach the degree of compaction adjusted by determining the production stoppage in the best use of the level of substrate in the funnel, thus staying until the funnel is again filled.

The technological innovation that allows the control is made up of vacuum gauges and air flow rate placed in the vacuum cylinder filling chamber and a computerized system, IHM, which analyzes the parameters identifying the ideal compaction and aeration, and once the predefined curves are met the computational device releases the movement of the traction and cutting unit.

To survey the compaction parameters using the various substrates, such as peat, coconut fiber, pine bark and other means for this purpose, as well as their mixtures, degree of humidity, and other means in the composition of the various substrate mixtures, from the use of drainage materials to fertilizers, a device composed of the filling chamber, vacuum chamber and filling time meter duly monitored by sensors of absolute gauge pressure air flow meters was mounted. With the help of machine learning technology, the ratio of the input parameters, the substrate formulation and its humidity was evaluated, with the generated compression degree defined the parameters of maximum and minimum values of atmospheric pressure in the filling chamber, maximum and minimum values of atmospheric pressure in the vacuum chamber, maximum and minimum values of air flow in the filling chamber and the maximum and minimum values in the vacuum chamber for given degree of substrate compaction.

Once the parameters have been defined for the most common substrate types and mixtures, the learning matrix was introduced in the IHM, the machine's computational system, so that it self-regulates to produce the tubes with the desired compaction. The computational unit will control the traction and cutting unit to ensure proper compaction.

If the system works only with a mixture and constant sizes of the biodegradable tube, these parameters will be placed directly in the CLP of the machine, without the need for the IHM.

The computational interface also allows manual adjustment of parameters. In this way the operator can adjust the parameters of the vacuum gauge through the interface and adjust the degree of compaction by opening and closing the valves that control the air flow of the vacuum pump that is connected in the vacuum chamber by suctioning the air into the vacuum chamber and filling chamber assembly. It sets the desired degree of compression and once reached the operator can save the values in the computational interface.

1. “MACHINE, CONTROL MEANS FOR SUBSTRATE COMPACTION AND PRODUCT OBTAINED” characterized in that it is a machine (3,4) having a device (FIGURE 9, w, e) that monitors a compaction process and a sensor to measure pressure in vacuum(Figure 9 e) and that measures the degree of compaction of the final product by checking whether the tube has been filled correctly.

2. “MACHINE, CONTROL MEANS FOR SUBSTRATE COMPACTION AND PRODUCT OBTAINED”, according to claim 1, characterized in that the machine (3,4) contains tube cutting system (b), paper traction unit+substrate (c), filling chamber (d), compaction degree control system (e, h), biodegradable paper tube (f), and vacuum chamber g).

3. “MACHINE, CONTROL MEANS FOR SUBSTRATE COMPACTION AND PRODUCT OBTAINED”, according to claim 1, characterized in that the vacuum chamber, where compaction is done (d) cover the inclusion of a hole to fit the measuring system of the variation of atmospheric pressure (W) inside the vacuum chamber.

4. “MACHINE, CONTROL MEANS FOR SUBSTRATE COMPACTION AND PRODUCT OBTAINED”, characterized in that the process (e, h) of the machine (5) starts the process (j) opening (k) the vacuum chamber valve (g) connected to the filling box, the monitoring/sensor system identifies if there is pressure difference (m) inside the filler chamber (d)—if there is no difference that shows that the degree of compaction of the substrate is adequate to the vacuum chamber valve remains open (k); since the pressure difference indicates the correct degree of compaction terminates the process and closes (k) the vacuum valve of the filling box (d), (q) and advances (r) the traction unit of the tube+substrate to form one more piece of the biodegradable paper tube (c) and finally follows(s) to the tube cutting system (b), terminating the process (t).

5. “MACHINE, CONTROL MEANS FOR SUBSTRATE COMPACTION AND PRODUCT OBTAINED”, according to claim 4, The electronic signals coming from the sensor (e) are processed by a computational system, CLP or man machine interface IHM, and the system's movement routine controls the movement signals of the whole assembly, based on the level of compaction and no longer on the timing.

6. “MACHINE, CONTROL MEANS FOR SUBSTRATE COMPACTION AND PRODUCT OBTAINED”, according to claim 4, In that the production cycle, when the compaction reaches the correct level by the compaction system, sensor, vacuum pump measurement (d and g), the traction system (c) is actuated and after the substrate tube is pulled to the correct length it is cut off (b).

7. “MACHINE, CONTROL MEANS FOR SUBSTRATE COMPACTION AND PRODUCT OBTAINED”, characterized in that the machine (3,4) is comprised of vacuum and air flow meters placed in the vacuum cylinder filling chamber and a computer system with pre-defined curves that release the movement of the traction and cutting unit.

8. “MACHINE, CONTROL MEANS FOR SUBSTRATE COMPACTION AND PRODUCT OBTAINED”, according to claims 7, characterized in that the computer interface allows the adjustment, saving and manual configuration of the parameters.
